(19) United States
(12) Patent Application Publication
(10) Pub. No.: US 2004/0145300 A1
(43) Pub. Date: Jul. 29, 2004

(54) Multiple lit-area(s) of electro-luminescent (EL) element(s) arrangement

(76) Inventor: Tseng-Lu Chien, Shi-Chi (TW)

Correspondence Address: BACON & THOMAS, PLLC, 625 SLATERS LANE, FOURTH FLOOR, ALEXANDRIA, VA, 22314

(21) Appl. No.: 10/667,787

(22) Filed: Sep. 23, 2003

Related U.S. Application Data
(63) Continuation-in-part of application No. 10/170,584, filed on Jun. 14, 2002, now abandoned.
(63) Continuation-in-part of application No. 10/285,451, filed on Nov. 1, 2002, now abandoned.
(63) Continuation-in-part of application No. 10/286,820, filed on Nov. 4, 2002.

(51) Int. Cl. H01J 1/62

(52) U.S. Cl. 313/498

(57) ABSTRACT

An electro-luminescent element arrangement for footwear includes multiple lit areas visible through windows and illuminated in sequence or according to a predetermined pattern to provide the impression of motion.

This application is a continuation-in-part of U.S. patent appliation Ser. No. 10/170,584, filed Jun. 14, 2002 and Ser. No. 10/285,451, filed Nov. 4, 2002 and Ser. No. 10/286,820, filed Nov. 4, 2002.

### BACKGROUND

The current invention relates to EL-element(s) may including panel, tube, strip which are arrangements for consumer applications such as those involving a Shoe, Slide, Slipper, Sandal, Automobiles, Boat, Bus, Aircraft, Garden, Traffic Equipment, Bag, Purse, House, Building, Christmas, Seasonal, Bicycle, Tricycle, Toy, Moving Device, Skating, Jogging, Watch, Garment, Apparel, Clothing, Jeans, Box, Tool Box, Working Lamp, Furniture, Giftware, Headgear, Jewelry, Hair Accessories, Partywear, Sign, Indoor lighting, Outdoor lighting, Street Lamp, Guide lamp, Bridge lamp, Traffic Cone, New Jersey Deck, Fence, Mail Box, House Number Light, Window Sign, Wall Sign, Poster, Pathway, Stair, Curb, Line divider for People, Evacuation light, Fishing Marker, Decoration Device for Safety, Decorating, Advertisement, Promotion, Point-Of-Purchase, Warning Light, Accent Light, Illumination light, Floor light, Delineator Guide Light, Evacuation light, Night light, Multiple Function Light, Portable light(s) which can be found in the market place with other light means such as L.E.D./Incandescent light bulb/ fluorescent tube, Neon Tube, HID lamp etc.

The current invention is same inventor of following issued US patents which listed below as U.S. patents including U.S. Pat. Nos. 5,746,504, 5,980,060,5,722,760, 5,504,397, 5,475,574, 5,479,325, 5,570,946, 5,469,342, 5,570,945, 5,704,705, 5,611,621, 5,860,727, 5,865,523, 5,879,069, 5,572,817, 5,752,337, 5,794,366, 5,833,508, 5,688,038, 5,871,269, 5,720,651, 5,806,960, 5,947,980, 5,775,016, 5,566,384, 5,876,108, 5,836,671, 5,601,358, 5,754,064, 5,921,653, 5,667,394, 6,082,867, 6,170,958, 6,183,101, 6,171,117, 5,926,440, 6,158,868, 6,182,282, 6,179,431, 5,599,088, 5,213,616, 6,169,431, 6,280,053, 6,170,958, 6,168,282, 5,926,440, 5,683,164, 6,183,101, 6,123,616, 6,280,053, 5,926,440, 5,754,064, 5,879,069 and other issued patents owned by current inventor.

The advantage of using electro-luminescent(EL) lighting elements in a variety of contexts are explained in several co-pending U.S. patent applications including U.S. patent application Ser. Nos. 08/305,294; 08/343,404; 08/343,915; 08/383,404; 08/383,405; 08/409,925; 08/421,647; 08/432,707; 08/438,373; 08/444,064; 08/436,007; 08/489,160; 08/498,258; 08/510,701; 08/522,940; 08/561,973; 08/611,049; 08/614,001; 08/522,940; 08/712,484; 08/734,872 which cover more uses for an electro-luminescent (EL) element(s).

The current invention mainly offer a proper arrangement for multiple of lit-areas on a single electro-luminescent element (hereafter as EL) incorporated front of silkscreen, stencil(s), cutout(s), window(s) to make the EL elements have the perfectly appearance and value for footwear applications. The arrangement is similar with co-inventor U.S. patents U.S. Pat. Nos. 5,572,817, 5,752,337, 5,794,366, 5,833,508 but the difference as following: The EL elements have multiple lit-area(s) which have its own electrodes to connect with signal end to get the each lit-area be turn on and off basing on the predetermined design of light function.

1. The EL elements have multiple lit-area(s) which have its owned window to be positioned and allow the people see the light from the said respective window. Furthermore the window may be made from group of consideration including the silkscreen process, stencil piece, cutout piece, masking piece, optics piece to make the light been seen by viewer for desired design.

2. The EL elements have different light effects by incorporated the lit-areas not limited to only one set for light function. For example, one set of lit-areas are in x-axis for chasing function and other set in y-axis for chasing effects. It also can be any combination for x, y, z axis with more exciting light effects.

3. The EL elements have multiple lit-area(s) can be separated with other lit-area(s) as individual piece which applied the conventional stitch, sewing, hot-seal, ultrasonic sealing, injection process, and assembly procedure to a main subject to make proper arrangement to create the value appearance.

4. The EL element has multiple lit-area(s) incorporated with special-means to design the lit-areas having circle, flow, or other exciting light effects also all these lit-areas can be arrange on anywhere of the main object to create the value appearance.

5. The EL element have multiple lit-areas with desired electrodes, conductive means, terminals, pieces, front piece arrangement, conventional assembly means to install the preferred lit-areas anywhere on main objects.

Basing on these (5) Major features and improvement, the current invention solves the problem that has held-up widespread acceptance of electro-luminescent elements for the past two decades.

### FIGURE

FIG. 1: Disclosure the 1^{st} embodiment which Electro-luminescent (EL) element have multiple of lit-area(s) in x-axis arrangement for the lit-area(s).

FIG. 2: Disclosure the 2^{nd} embodiment which EL element has multiple of lit-areas which are in y-axis arrangement for the lit-area(s).

FIG. 3: Disclosure the 3^{rd} embodiment which EL element has separated 3 pieces of the lit-areas which may incorporating with front piece may selected from group of combination for stencil, window, silkscreen, optics device, injection process arrangement to assemble anywhere as desired design on the main subject for value appearance

FIG. 4: Disclosure the 4^{th} embodiment which EL element has multiple of lit-areas for making the light effects in x-axis and y-axis with light effects for combination effects.

FIG. 5: Disclosure the 5^{th} embodiment which EL element has multiple of lit-areas for making the light effects in x-axis and y-axis and z-axis while bend the EL element to a curve so light effects will have x-y-z axis light effects.

FIG. 6: Disclosure the 6^{th} embodiment which EL element has multiple of lit-areas for making the light effects in x+y+z axis but also can design the desired lit-area in predetermined arrangement so can have rotating, flowing or other special light effects which created by special-means to make light have such exciting effects.

FIG. 7: Disclosure the 7^{th} embodiment which EL element has multiple of lit-areas for making the lit-areas with positioned of windows respectively of front sheet which maybe in a form of silkscreen(s), stencil(s), cutout(s), optics device(s), masking process to allow the lit-area(s) can be proper assembled on anywhere of the main object as desired.

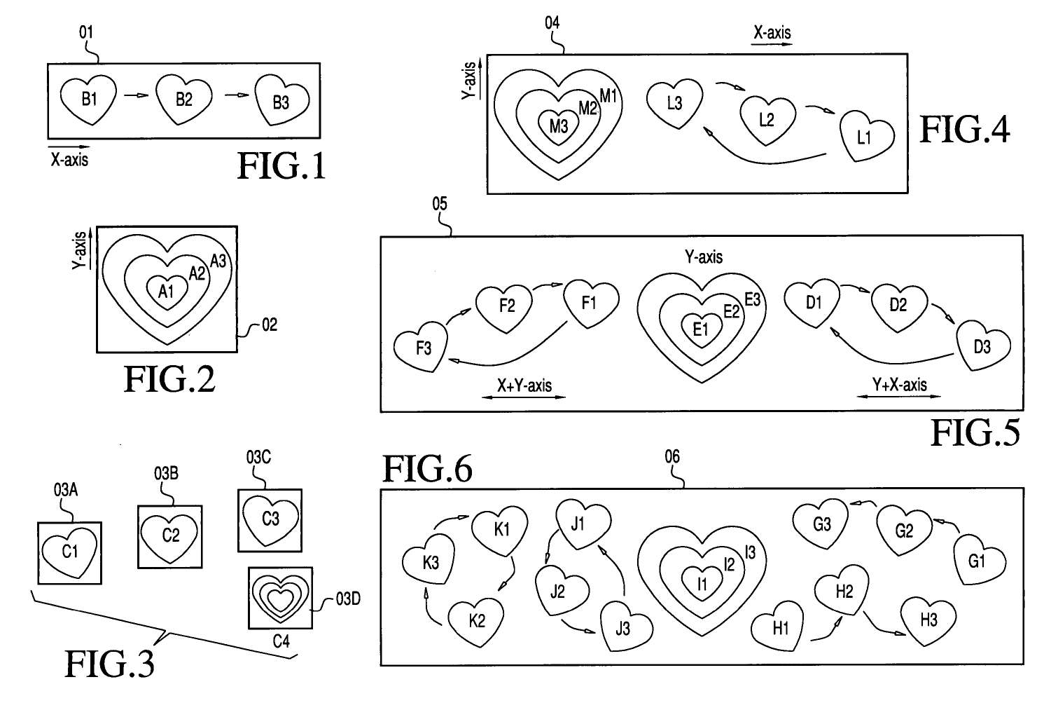

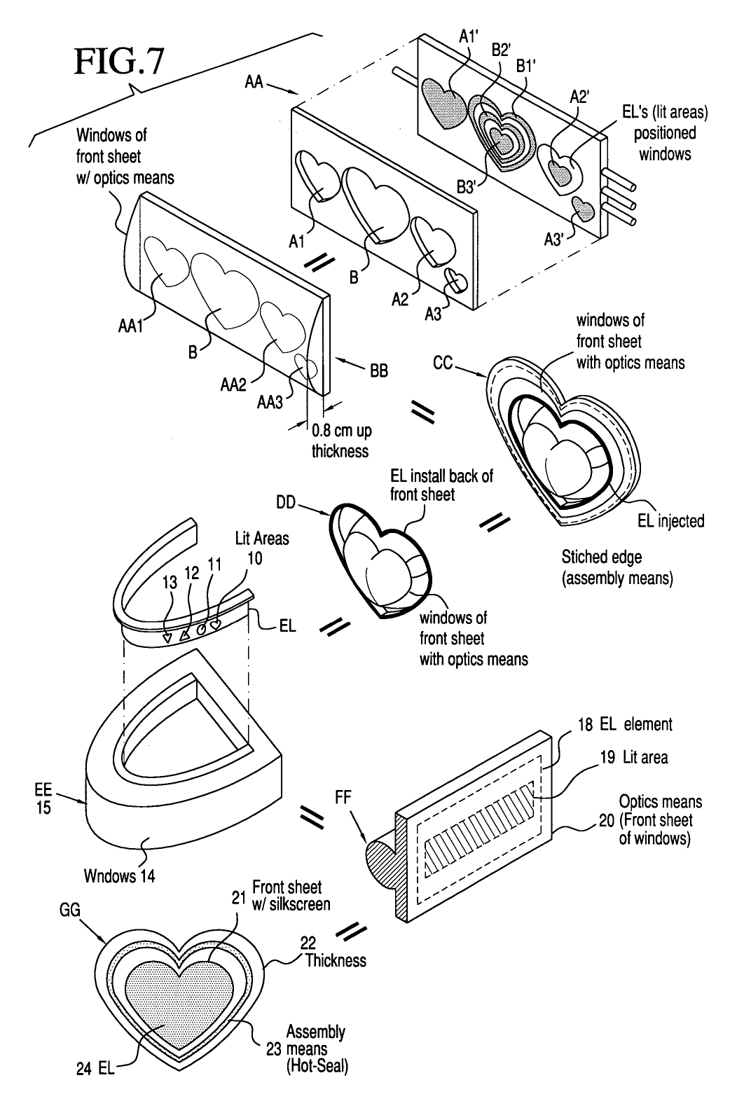

### DETAIL DESCRIPTION

The Multiple of lit-areas for Electro-luminescent (EL) elements arrangement as current invention which teach (a)the window(s) concept positioned the lit-area(s) respectively to allow the light been seen by viewer. It also teach(b) the window means may selected from group combination from silkscreen(s), cutout(s), masking(s), Optics device(s), Injection process(s) and incorporated with the conventional sewing, stitching, glue, hot sealing, ultrasonic sealing, injection process, overlay, underlay, sandwich to assemble the lit-area(s) on anywhere as desired to main object to create value appearance. It also teach (c) the injection procedure to seal the EL element into light transmitting material as co-pending patent of nvironment treatment of electro-luminescent element It also teach (d) the special-design for the light flashing arrangement so can create the circle, flow light effects. It also teach (f) the EL element lit-areas arrangement to get the light in x,y,z axis dimension to create the more attractive light effects.

From FIG. (1) can see the EL element has three lit-areas (B1) (B2) (B3) which use the Phosphors coated on these areas only to save the expensive material. Each lit-area phosphors are connected by conductive means which may selected from group combination by silver-paste, ITO material, or equivalent material which allow the current be delivered by these material. The light functions controlled by Integrated Circuit (IC) for desired functions may including the scan, chasing, pair-flashing, combination flashing, random, fade in and fade out, sequential, or other available functions from marketing available IC. However, these three lit-areas are in X-axis for light performance. From the FIG. (2) can see the lit-areas (A1) (A2) (A3) have the Y-axis dimensional for moving effects. This Y-axis dimensional moving light effects have other taste and create some eye-catching effects. From FIG. (4) can see the combination for the X-axis light moving effects which from lit-areas (L1) (L2) (L3) and Y-axis light moving effects which from lit-areas (M1) (M2) (M3). Furthermore, the proper bending arrangement for the element (04) to curve shape, the light effects will change from X-Y dimension to the X-Y-Z axis for more visible angle to increase the main object light effects. From FIG. (5) the element (05) has (F1) (F2) (F3) (E1) (E2) (E3) (D1) (D2) (D3). The group of the lit-areas (D1) (D2) (D3) and group of the lit-areas (F1) (F2) (F3) have the light moving cover the x-y axis. The group of the lit-areas (E1) (E2) (E3) have the more y-axis light moving effects. The combination for the light moving effects for X-axis, Y-axis of the EL elements with bending arrangement to create the Z-axis light moving dimension are the current invention features.

From the FIG. (6) teach the special-means to make the group of lit-areas with the circle, flow performance by connected at least two lit-areas together to make the light special performance. From FIG. (6) the group (G1) (G2) (G3) and (H1) (H2) (H3), the (G1) and (H1) are designed to connect together as 1^{st} flashing point. The (G2) and (H2) are designed to connect together as 2^{nd} flashing point. The (G3) and (H3) are connected together as 3^{rd} flashing point. While these flashing point connect with desired IC, the light effects will be (G1)+(H1)→(G2)+(H2)→(G3)+(H3) like light become a circle light special performance repeat again and again under predetermined function. The same two small circle special performance can see from the group lit-areas (J1) (J2) (J3) and (K1) (K2) (K3). The lit-areas (J1)→(J2)→(J3) will become an anti-counter wise special performance. The lit-area (K1)→(K2)→(K3) will be counter wise special performance. These special arrangement to connect at least (2) lit-areas of EL elements to flash at the same time to get the special light performance can create a lot of exciting light effects to make eye-catching effects. Furthermore, the all said lit-areas can be selected from plurality of color(s) so can create full colors light to match the main object requirement.

From FIG. (3) can see the each lit-areas are in a individual EL element piece as element (03A), (03B), (03C), (03D) are total four pieces of EL elements application. The each piece can has its owned window of the front sheet which may be treated by silkscreen(s), stencil(s), cutout(s), optics-piece(s), injection piece(s), masking(s) with proper assembly means so can easily attached to the main object to have value appearance. The assembly means may select from group combination including hot-sealing, ultrasonic, stitch, sewing, glue, rivet, staple, Velcro tape to assemble each individual lit-area on the main object for perfect appearance which the windows may have the characters, cartoon, indicia, geometric design, drawing which made by silkscreen.

Furthermore, the window may cover at least on lit-areas for certain requirement as FIG. (7) Window (B) cover the lit-areas (B1) (B2) (B3) which is one window covered for more than one lit-areas.

From the FIG. (7) can see the relation of the Window of the front sheet v.s. lit-areas. From the FIG. (7) the EL element (AA) has three windows of the front sheet. These windows are made by Silkscreen process, cutout process, masking process, injection process, optics process to allow the light can be passing though from these windows to be seen. The rest of areas except of the window have no lit-areas arranged to save the cost of phosphor material of the EL element.

The respective lit-areas of each window (A1) (B) (A2) (A3) are positioned the said windows are (A1 (B1 (B2 (B3 (A2 (A3 . The window (A1) has the lit-area (A1 positioned. The window (B) has the lit-areas (B1 (B2 (B3 position. The arrangement is basing on the market requirement for one window has more than one lit-area. This kind of application is perfectly for Y-axis moving light effects or cartoon designs. The Front Sheet (AA) can be replaced by the front sheet with optics arrangement. For Example, the Front piece (BB) is a convex lens design with center thicker than edge to make the light image with dimension, size, image, color, brightness changes while the light and indicia passing though this convex lens.

The Front Sheet (BB) with 4 windows which may created by silkscreen process, cutout process, masking process, stencil process, injection process, add-on piece process to let the lit-areas light and indicia been seen by viewer. Incorporating the earlier description of the FIG. (3) for separated elements, the each separated EL element may seal the element into plastic injection unit (CC). The front sheet with preferred window in a injection unit which the EL element are sealed inside the plastic injection unit. The EL element can have silkscreen printing on the EL surface so can have the indicia to let the unit have value appearance. The alternative way is to put the EL element underlay the injection unit front sheet (DD) which may add a small silkscreen plastic sheet within the injection unit and EL element. Because the injection unit may have the convex lens which the thickness should be minimum 0.8 cm, preferred from 0.8 cm up to make better optics properties such as change the light, indicia, image, focus, light properties of the lit-area(s).

The Front sheet (EE) (15) is also incorporated the front sheet which have the silkscreen printing windows on the EL elements surface to cover the all areas except of the lit-areas (10) (11) (12) (13) and incorporated the optic injected plastic lens window (14). This applications use 1^{st} window which by silkscreen process and 2^{nd} window for optics lens.

These combination are cover at least one of windows to make the lit-areas have good and value appearance.

The Front Sheet (FF) which are made by injection process which have the EL element (18) are injected within the material or underlay of the injected plastic piece depend on the market requirement and efficiency for making assembly. The Front Sheet with the window which are almost 270 degree of radius solid convex lens which thickness are preferred more than 0.8 cm to allow the lit-area (19) have image changes may including size, color, brightness, indicia, image of the lit-area(s). The plastic injection piece and EL element may have some extra space to allow people to have proper assembly means to install this light kits on main object well may use the means selected from group combination including stitch, glue, Velcro, ultrasonic sealing, hot seal, staple, rivet.

The Front Sheet (GG) is equivalent method of the Front sheet (AA), (BB), (CC), (DD), (EE), (FF). The difference the front sheet of the (GG) may is only simple silkscreen process or a thin material with silkscreen process to create the window(s) to position the lit-area underlay to allow the light been seen by viewer.

Although preferred embodiments of the invention have been described in details. It will be appreciated that the scope of the invention is not to be limited to the described embodiments, but rather that the invention is to be interpreted in accordance with the appended claims.

1. The multiple lit-area(s) of Electro-Luminescent element(s) arrangement for footwear incorporated:
At least one electro-luminescent element(s) having multiple of lit-area(s) with desired light output(s), color(s), brightness, designs, in geometric form with preferred conductive mean(s) to connect with electrode(s).
The improvement:
The said lit-area(s) with phosphor coated on preferred area(s) of said element with the said conduct means connected together with signal end(s) to make a light moving in desired dimension may selected from group combination of x, y, z dimensions.
Further more, the said lit-area(s) has its owned window position respectively to allow the light emit out from said window(s) to be seen by viewer. The said window be made by process which may selected from group combination of stencil(s), cutout(s), silkscreen(s), injection(s), masking(s), incorporated with assembly means to install on anywhere of the footwear to create value light appearance.

2. The multiple lit-area(s) of electro-luminescent element(s) arrangement for footwear as claim 1, the said windows means a process to make the EL element lit-area(s) light beam to emit out from the said window(s).

3. The multiple lit-area(s) of electro-luminescent element(s) arrangement for footwear as claim 1, the said lit-area(s) can be arranged in any combination selected from single element, multiple pieces of elements for applications.

4. The multiple lit-area(s) of electro-luminescent element(s) arrangement for footwear as claim 1, the said lit-area(s) with proper assembly means to install anywhere of the footwear to allow light to be seen.

5. The multiple lit-area(s) of electro-luminescent element(s) arrangement for footwear as claim 1, the said light moving means the lit-area(s) emit light from the same or different elements.
